(19) United States
(12) Patent Application Publication
(10) Pub. No.: US 2007/0206281 A1
(43) Pub. Date: Sep. 6, 2007

(54) Projection screen

(76) Inventor: Yu Sheng Teng, Lujhou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/364,201

(22) Filed: Mar. 1, 2006

(51) Int. Cl. G03B 21/60

(52) U.S. Cl. 359/452

(57) ABSTRACT

A projection screen includes first and second basic materials, at least one diffusing layer sandwiched between the first and the second basic materials, a writing layer coating the second basic material, and a reflecting layer over the first basic material; the writing layer allows the ink of whiteboard markers to adhere on and get erased therefore the projection screen allows people to write thereon with whiteboard markers besides being used for images to be projected on by a projector.

### BACKGROUND OF THE INVENTION

1. Field of the invention

The present invention relates to a projection screen, more particularly one, which allows the ink of whiteboard markers to adhere on and get erased, thus allowing people to write thereon with whiteboard markers besides being used for images to be projected on.

2. Brief Description of the Prior Art

Projectors are usually used to project figures, charts etc on screens to show information in a meeting or lecture, thus helping the audience to understand. There are two major ways to project images, front projection and rear projection; a projector is placed in front of a screen in front projection while a projector is placed behind a screen in rear projection.

However, no matter which projecting way is used, the projection screen doesn't allow people to write or make marks thereon with markers. Consequently, the user either has to take the trouble to prepare and use a whiteboard and markers in a lecture or add the extra information and words to the contents of the projector films previously before printing the contents on projector films. Neither of the above two ways is convenient.

### SUMMARY OF THE INVENTION

It is a main object of the invention to provide an improvement on a projection screen to overcome the above-mentioned inconvenience. The projection screen of the present invention includes first and second basic materials, at least one diffusing layer sandwiched between the first and the second basic materials, and a writing layer coating the second basic material. The writing layer allows the ink of whiteboard markers to adhere on and easily get erased therefore the projection screen allows people to write thereon with whiteboard markers besides being used for images to be projected on.

### BRIEF DESCRIPTION OF THE DRAWINGS

The present invention will be better understood by referring to the accompanying drawings, wherein:

FIG. 1 is a view of the first preferred embodiment of a projection screen in the present invention, and

FIG. 2 is a view of the second preferred embodiment.

FIG. 3 is a view of the third preferred embodiment,

FIG. 4 is a view of the fourth preferred embodiment

FIG. 5 is a view of the fifth preferred embodiment

FIG. 6 is a view of the sixth preferred embodiment.

FIG. 7 is a view of the seventh preferred embodiment,

FIG. 8 is a view of the eighth preferred embodiment

FIG. 9 is a view of the ninth preferred embodiment

FIG. 10 is a view of the tenth preferred embodiment.

FIG. 11 is a view of the eleventh preferred embodiment, and

FIG. 12 is a view of the twelfth preferred embodiment.

### DETAILED DESCRIPTION OF THE PREFERRED EMBODIMENTS

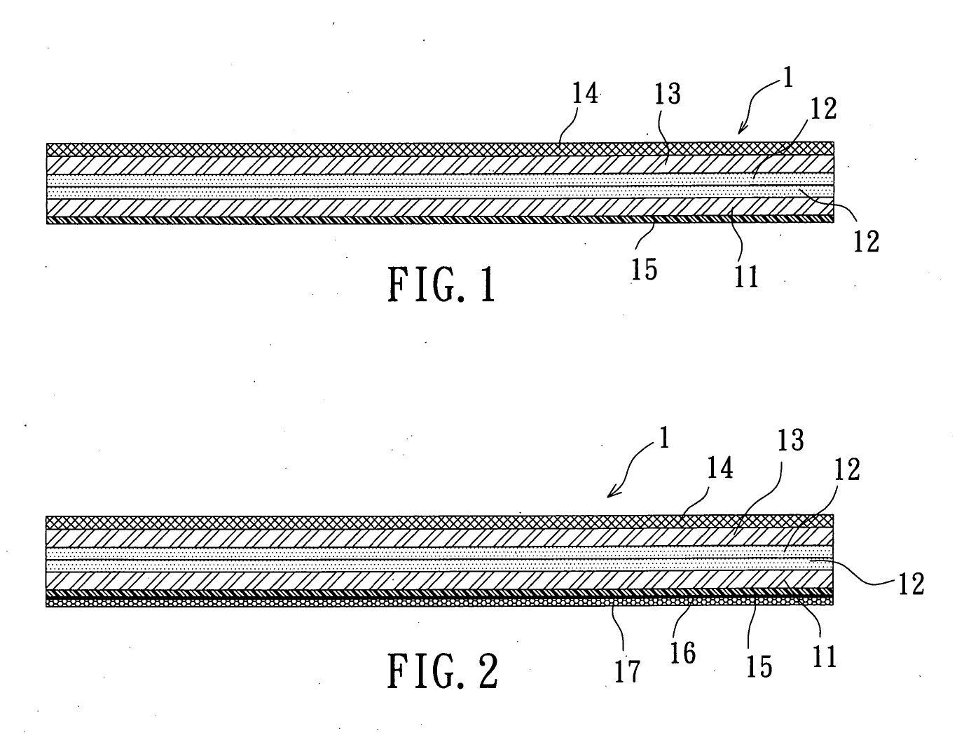

Referring to FIG. 1, a first preferred embodiment of a projection screen 1, which is provided for use in front projection, includes a polymer plastic basic material 11, at least two diffusing layers 12 over an upper side of the polymer plastic basic material 11, another polymer plastic basic material 13 over an upper side of an uppermost one of the diffusing layers 12, a writing layer 14 coating an upper side of the polymer plastic basic material 13, and a reflecting layer 15 over a lower side of the polymer plastic basic material 11; there are two diffusing layers 12 in the first preferred embodiment shown in FIG. 1.

Referring to FIG. 2, a second preferred embodiment of a projection screen 1 for use in front projection includes a polymer plastic basic material 11, at least two diffusing layers 12 over an upper side of the polymer plastic basic material 11, another polymer plastic basic material 13 over an upper side of an uppermost one of the diffusing layers 12, a writing layer 14 coating an upper side of the polymer plastic basic material 13, a reflecting layer 15 over a lower side of the polymer plastic basic material 11, a black adhesive layer 16 over a lower side of the reflecting layer 15, and a detaching film 17 stuck to a lower side of the black adhesive layer 16; there are two diffusing layers 12 in the second preferred embodiment shown in FIG. 2. Images projected on the projection screen will be more distinct because of the color of the black adhesive layer 16. Further, the projection screen can be fixed on an object, on which images are to be projected, by means of sticking the black adhesive layer 16 to the object after the detaching film 17 is removed.

The polymer plastic basic materials 11 and 13 can be PET (Polyethylene Terephthalate), PP (Polypropylene), PEN, PE (polyethylene), PA (nylon), PMMA (acryl) or PC (Polycarbonate).

The ingredients of the diffusing layers 12 can include powdery polymer diffusing particulates (e.g. acryl, melamine, and silicone particulates) with diameters between 1 μ and 30 μ, titanium dioxide, and viscid liquid resin, which are mixed together. Or alternatively, the diffusing layer 12 can be made of only one kind of material chosen from a group including titanium dioxide, polymer diffusing acryl particulates, melamine, and silicone. The diffusing layer 12 also can be made of two or three kinds of materials chosen from a group including titanium dioxide, polymer diffusing acryl particulates, melamine, and silicone.

Ingredients of the chemical coating material of the writing layer 14 can include wear-resistant UV-curable melamine resin, of which the proportion to the coating material of the writing layer 14 is between 95% and 99%, and photoinitiator, of which the proportion to the coating material of the writing layer 14 is between 1% and 5%; when UV-curable melamine resin and photoinitiator are mixed, condensation will occur, and in turn the surface tension on the writing layer 14 will be in such a range as to allow the ink of whiteboard markers to adhere on and easily get erased from the projection screen.

Instead, ingredients of the chemical coating material of the writing layer 14 can include UV-curable polyurethane resin, of which the proportion to the whole coating material is between 95 and 99%, and photoinitiator, of which the proportion to the coating material is between 1% and 5%.

And instead, ingredients of the chemical coating material of the writing layer 14 can include UV-curable acrylic resin, of which the proportion to the whole coating material is between 95% and 99%, and photoinitiator, of which the proportion to the coating material is between 1% and 5%. And instead, ingredients of the chemical coating material of the writing layer 14 can include melamine, of which the proportion to the whole coating material is between 10% and 50%, polyurethane, of which the proportion to the whole coating material is between 5% and 25%, UV-curable acrylic copolymer resin, of which the proportion to the coating material is between 10% and 50%, and photoinitiator, of which the proportion to the whole coating material is between 1% and 5%.

Further, ingredients of the chemical coating material of the writing layer 14 can include melamine, of which the proportion to the whole coating material is between 70% and 90%, UV-curable polyurethane resin, of which the proportion to the whole coating material is between 5% and 25%, and photoinitiator, of which the proportion to the whole coating material is between 1% and 5% instead.

And, ingredients of the chemical coating material of the writing layer 14 can include polyurethane, of which the proportion to the whole coating material is between 5% and 25%, UV-curable acrylic copolymer resin, of which the proportion to the coating material is between 70% and 90%, and photoinitiator, of which the proportion to the whole coating material is between 1% and 5%.

The reflecting layer 15 can be made of aluminum or silver. And, the material of the adhesive layer 16 can be acryl, rubber or silicone.

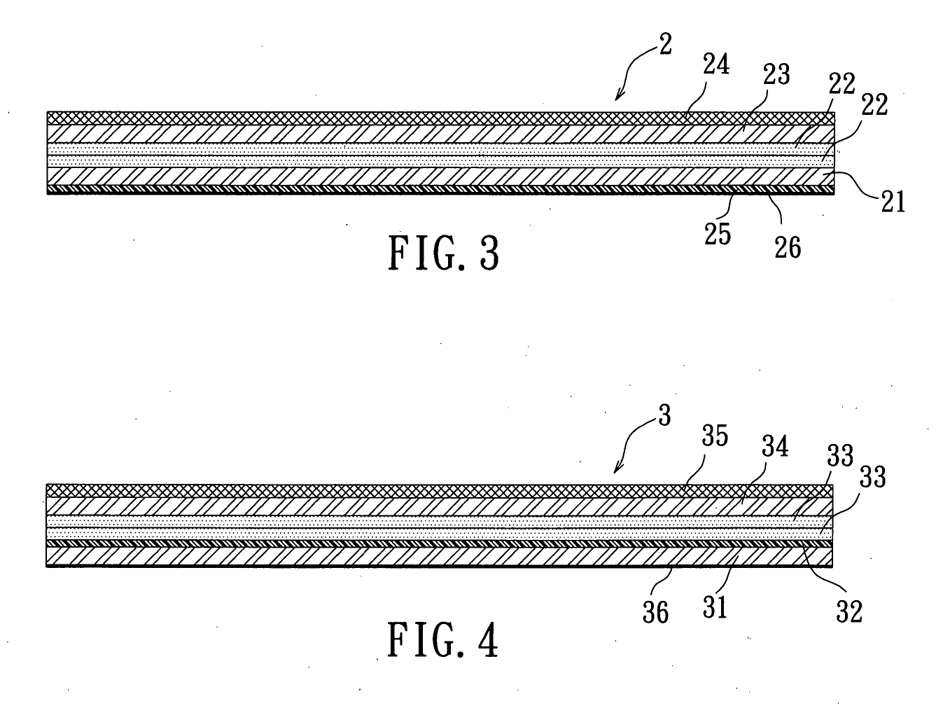

Referring to FIG. 3, a third preferred embodiment of a projection screen 1 for use in front projection includes a polymer plastic basic material 21, at least one diffusing layers 22 over an upper side of the polymer plastic basic material 21, another polymer plastic basic material 23 over an upper side of an uppermost one of the diffusing layers 22, a writing layer 24 coating an upper side of the polymer plastic basic material 23, a reflecting layer 25 over a lower side of the polymer plastic basic material 21, and a blackening layer 26 over a lower side of the reflecting layer 25.

Referring to FIG. 3, a third preferred embodiment of a projection screen 2 for use in front projection includes a polymer plastic basic material 21, at least one diffusing layers 22 over an upper side of the polymer plastic basic material 21, another polymer plastic basic material 23 over an upper side of an uppermost one of the diffusing layers 22, a writing layer 24 coating an upper side of the polymer plastic basic material 23, a reflecting layer 25 over a lower side of the polymer plastic basic material 21, and a blackening layer 26 over a lower side of the reflecting layer 25.

Referring to FIG. 4, a fourth preferred embodiment of a projection screen 3 for use in front projection includes a polymer plastic basic material 31, a reflecting layer 32 over an upper side of the polymer plastic basic material 31, at least one diffusing layers 33 over an upper side of the reflecting layer 32, another polymer plastic basic material 34 over an upper side of an uppermost one of the diffusing layers 33, a writing layer 35 coating an upper side of the polymer plastic basic material 34, and a blackening layer 36 over a lower side of the polymer plastic basic material 31; there are two diffusing layers 33 on the fourth preferred embodiment shown in FIG. 4.

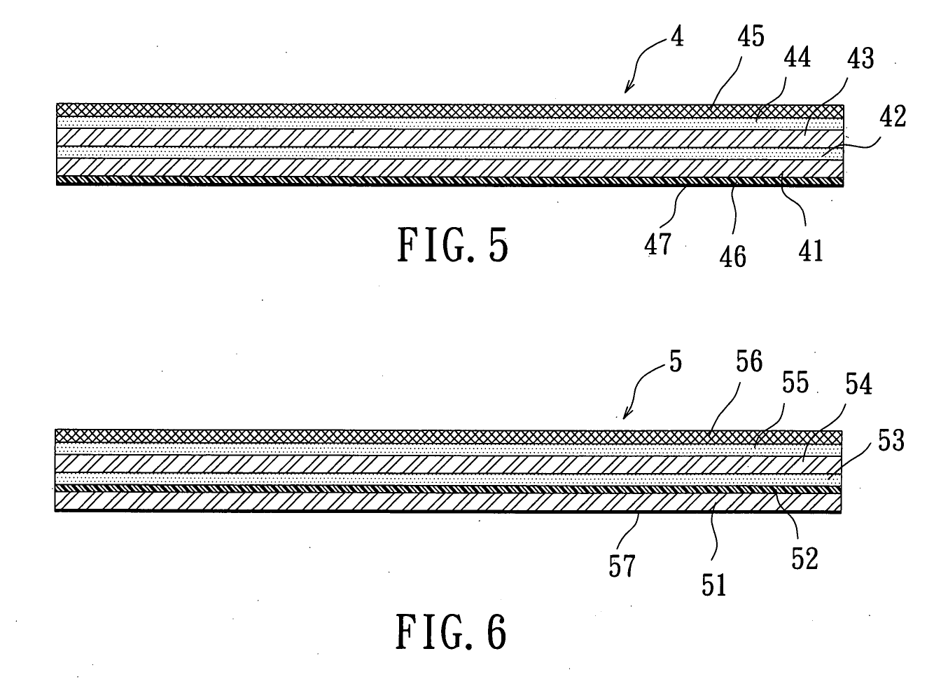

Referring to FIG. 5, a fifth preferred embodiment of a projection screen 4 for use in front projection includes a polymer plastic basic material 41, a diffusing layer 42 over an upper side of the polymer plastic basic material 41, another polymer plastic basic material 43 over an upper side of the diffusing layer 42, another diffusing layer 44 over an upper side of the polymer plastic basic material 43, a writing layer 45 coating an upper side of the diffusing layer 44, a reflecting layer 46 over a lower side of the polymer plastic basic material 41, and a blackening layer 47 over a lower side of the reflecting layer 46.

Referring to FIG. 6, a sixth preferred embodiment of a projection screen 5 for use in front projection includes a polymer plastic basic material 51, a reflecting layer 52 over an upper side of the polymer plastic basic material 51, a diffusing layer 53 over an upper side of the reflecting layer 52, another polymer plastic basic material 54 over an upper side of the diffusing layer 53, another diffusing layer 55 over an upper side of the polymer plastic basic material 54, a writing layer 56 coating an upper side of the diffusing layer 55, and a blackening layer 57 over a lower side of the polymer plastic basic material 51.

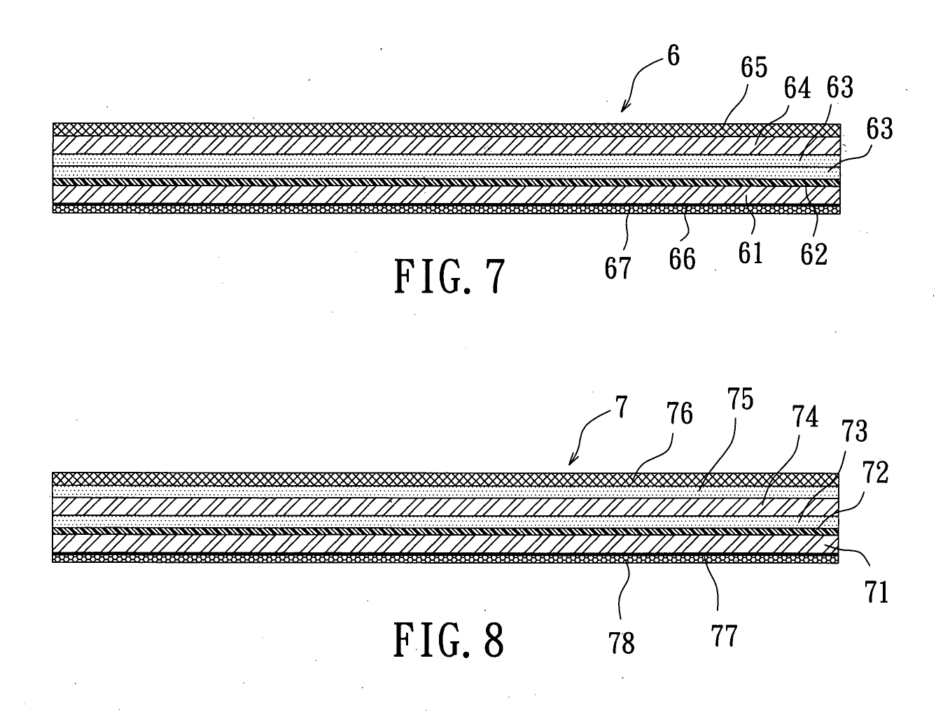

Referring to FIG. 7, a seventh preferred embodiment of a projection screen 6 for use in front projection includes a polymer plastic basic material 61, a reflecting layer 62 over an upper side of the polymer plastic basic material 61, at least one diffusing layers 63 over an upper side of the reflecting layer 62, another polymer plastic basic material 64 over an upper side of an uppermost one of the diffusing layers 63, a writing layer 65 coating an upper side of the polymer plastic basic material 64, a black adhesive layer 66 over a lower side of the polymer plastic basic material 61, and a detaching film 67 stuck to a lower side of the black adhesive layer 66; the projection screen 6 can be stuck on an object by means of the black adhesive layer 66 after the detaching film 67 is removed; there are two diffusing layers 63 in the seventh preferred embodiment shown in FIG. 7.

Referring to FIG. 8, a eighth preferred embodiment of a projection screen 7 for use in front projection includes a polymer plastic basic material 71, a diffusing layer 72 over an upper side of the polymer plastic basic material 71, a second polymer plastic basic material 73 over an upper side of the diffusing layer 22, a second diffusing layer 74 over an upper side of the second polymer plastic basic material 73, a writing layer 75 coating an upper side of the second diffusing layer 74, a reflecting layer 76 over a lower side of the polymer plastic basic material 71, a black adhesive layer 77 over a lower side of the reflecting layer 76, and a detaching film 78 over a lower side of the black adhesive layer 77; thus, the projection screen 7 can be stuck on an object after the detaching film 78 is removed.

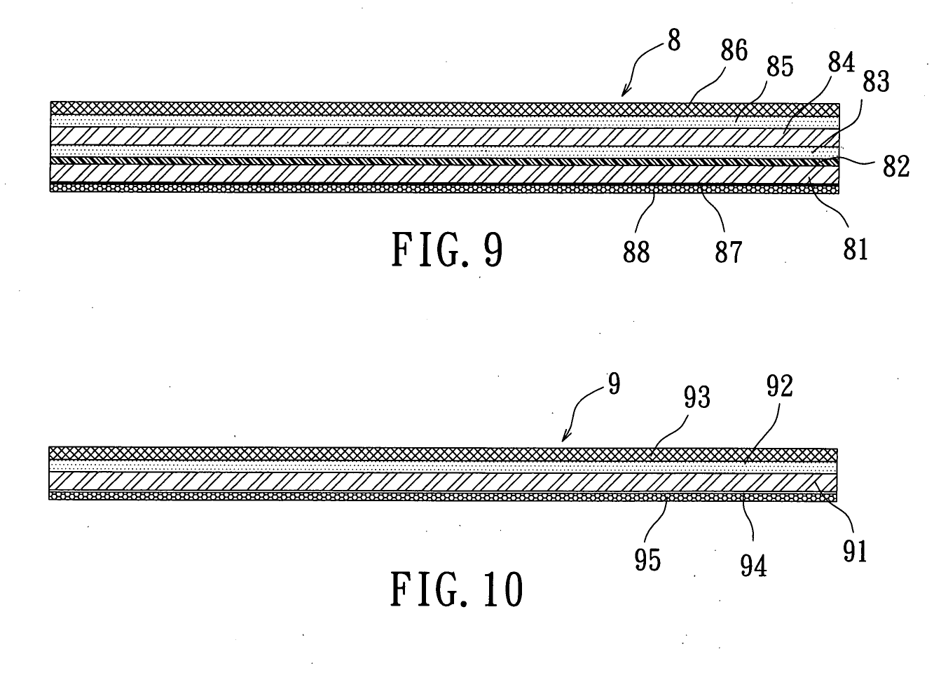

Referring to FIG. 9, a ninth preferred embodiment of a projection screen 8 for use in front projection includes a polymer plastic basic material 81, a reflecting layer 82 over an upper side of the polymer plastic basic material 81, a diffusing layer 83 over an upper side of the reflecting layer 82, a second polymer plastic basic material 84 over an upper side of the diffusing layer 83, a second diffusing layer 85 over an upper side of the second polymer plastic basic material 84, a writing layer 86 coating an upper side of the second diffusing layer 85, a black adhesive layer 87 over a lower side of the polymer plastic basic material 81, and a detaching film 88 over a lower side of the black adhesive layer 87; thus, the projection screen 8 can be stuck on an object after the detaching film 88 is removed.

The following preferred embodiments of a projection screen of the present invention are provided for use in rear projection:

Referring to FIG. 10, a tenth preferred embodiment of a projection screen 9 includes a polymer plastic basic material 91, at least one diffusing layers 92 over an upper side of the polymer plastic basic material 91, a writing layer 93 coating an upper side of an uppermost one of the diffusing layers 92, a transparent adhesive layer 94 over a lower side of the polymer plastic basic material 91, and a detaching film 95 over a lower side of the transparent adhesive layer 94; thus, the projection screen 9 can be stuck on an object after the detaching film 95 has been removed; there is single diffusing layer 93 in the present preferred embodiment shown in FIG. 10.

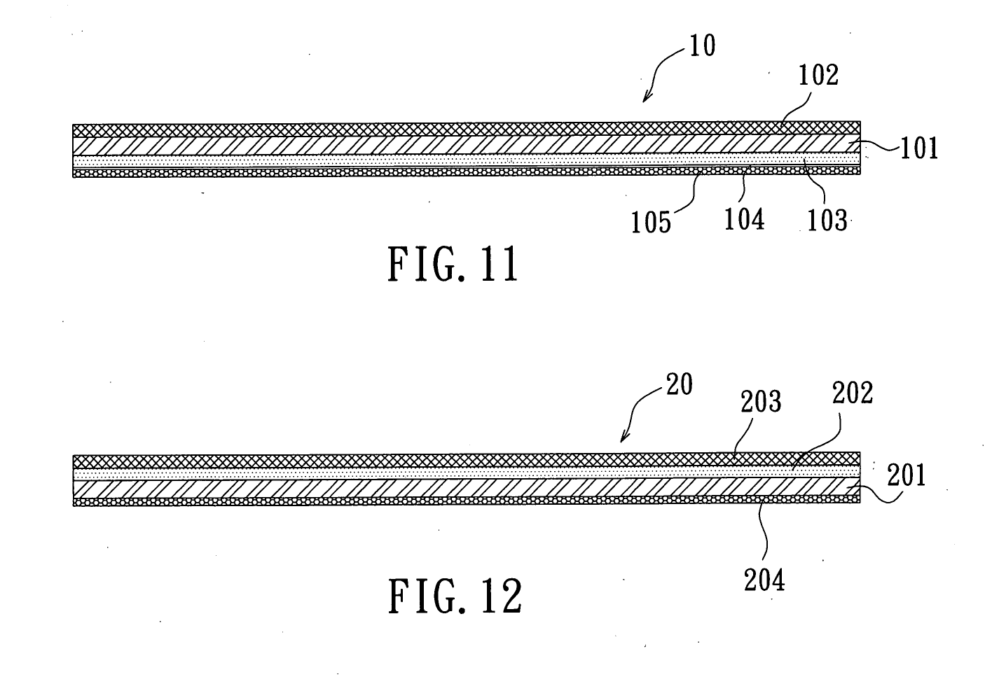

Referring to FIG. 11, a eleventh preferred embodiment of a projection screen 10 includes a polymer plastic basic material 101, a writing layer 102 over an upper side of the polymer plastic basic material 101, at least one diffusing layers 103 over a lower side of the polymer plastic basic material 101, a transparent adhesive layer 104 coating a lower side of a lowermost one of the diffusing layers 103, and a detaching film 105 over a lower side of the transparent adhesive layer 104; thus, the projection screen 10 can be stuck on an object after the detaching film 105 is removed; there is single diffusing layer 103 in the present preferred embodiment shown in FIG. 11.

Referring to FIG. 12, a twelfth preferred embodiment of a projection screen 20 includes a polymer plastic basic material 201, a writing layer 202 over an upper side of the polymer plastic basic material 201, at least one adhesive diffusing layers 203 over a lower side of the polymer plastic basic material 201, and a detaching film 204 over a lower side of a lowermost one of the diffusing layers 203; thus, the projection screen 20 can be stuck on an object after the detaching film 204 is removed; there is single diffusing layer 203 in the present preferred embodiment shown in FIG. 12.

The polymer plastic basic materials 21, 23, 31, 34, 41, 43, 51, 54, 61, 64, 71, 73, 81, 84, 91, 101, and 201 of the last ten preferred embodiments can be PET (Polyethylene Terephthalate), PP (Polypropylene), PEN, PE (polyethylene), PA (nylon), PMMA (acryl) or PC (Polycarbonate).

The writing layers 24, 35, 45, 66, 65, 75, 86, 93, 102, and 202 have polymer diffusing particulates added therein, which can be PMMA (acryl), PU or silicone particulates, and of which the diameters are between 0.1 μ and 20 μ; furthermore, the proportion of the polymer diffusing particulates to the writing layers is between 2% and 30%.

Materials of the reflecting layers 25, 32, 46, 52, 62,76, and 82 can be aluminum or silver. And, materials of the black adhesive layers 16, 66, 77, and 87 and materials of the transparent adhesive layers 94 and 104 can be acryl, rubber or silicone.

What is claimed is:

1. A projection screen, comprising
a first polymer plastic basic material;
at least two diffusing layers over an upper side of the polymer plastic basic material;
a second polymer plastic basic material over an upper side of an uppermost one of the diffusing layers;
a writing layer coating an upper side of the second polymer plastic basic material; and
a reflecting layer over a lower side of the first polymer plastic basic material.

2. The projection screen as recited in claim 1 further comprising a black adhesive layer over a lower side of the reflecting layer, and a detaching film stuck to a lower side of the black adhesive layer.

3. The projection screen as recited in claim 1, wherein a material of the black adhesive layer is one member chosen from a group including acryl, rubber, and silicone, and the polymer plastic basic materials are made of one member chosen from a group including PET (Polyethylene Terephthalate), PP (Polypropylene), PEN, PE (polyethylene), PA (nylon), PMMA (acryl), and PC (Polycarbonate), and ingredients of the diffusing layer include powdery polymer diffusing particulates with diameters between 1 μ and 30 μ, titanium dioxide, and viscid liquid resin, which are mixed together, and a material of the reflecting layer is one member chosen from a group including aluminum and silver.

4. The projection screen as recited in claim 3, wherein the polymer diffusing particulates are made of one member chosen from a group including acryl, melamine, and silicone.

5. The projection screen as recited in claim 3, wherein the polymer diffusing particulates are made of a mixture of two members chosen from a group including acryl, melamine, and silicone.

6. The projection screen as recited in claim 3, wherein the polymer diffusing particulates are made a mixture of acryl, melamine, and silicone.

7. The projection screen as recited in claim 1, wherein a coating material of the writing layer is a mixture of wear-resistant UV-curable melamine resin, and photoinitiator; proportion of the wear-resistant UV-curable melamine resin to said coating material being between 95% and 99%; proportion of the photoinitiator to said coating material being between 1% and 5%.

8. The projection screen as recited in claim 1, wherein a coating material of the writing layer is a mixture of UV-curable polyurethane resin, and photoinitiator; proportion of the UV-curable polyurethane resin to the coating material of the writing layer being between 95% and 99%; proportion of the photoinitiator to the coating material being between 1% and 5%.

9. The projection screen as recited in claim 1, wherein a coating material of the writing layer is a mixture of UV-curable acrylic resin, and photoinitiator; proportion of the UV-curable acrylic resin to said coating material being between 95% and 99%; proportion of the photoinitiator to said coating material being between 1% and 5%.

10. The projection screen as recited in claim 1, wherein a coating material of the writing layer is a mixture of melamine, polyurethane, UV-curable acrylic copolymer resin, and photoinitiator; proportion of the melamine to said coating material being between 10% and 50%; proportion of the polyurethane to said coating material being between 5% and 25%; proportion of the UV-curable acrylic copolymer resin to said coating material being between 10% and 50%; proportion of the photoinitiator to said coating material being between 1% and 5%.

11. The projection screen as recited in claim 1, wherein a coating material of the writing layer is a mixture of melamine, UV-curable polyurethane resin, and photoinitiator; proportion of the melamine to said coating material being between 70% and 90%; proportion of the UV-curable polyurethane resin to said coating material being between 5% and 25%; proportion of the photoinitiator to said coating material being between 1% and 5%.

12. The projection screen as recited in claim 1, wherein a coating material of the writing layer is a mixture of polyurethane, and UV-curable acrylic copolymer resin; proportion of the polyurethane to said coating material being between 5% and 25%; proportion of the UV-curable acrylic copolymer resin to said coating material being between 70% and 90%; proportion of the photoinitiator to said coating material being between 1% and 5%.

13. A projection screen, comprising
a first basic material,
at least one diffusing layers over an upper side of the basic material,
a second basic material over an upper side of an uppermost one of the diffusing layers,
a writing layer coating an upper side of the second basic material, and
a reflecting layer over a lower side of the first basic material, and
a blackening layer over a lower side of the reflecting layer.

14. The projection screen as recited in claim 13, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone, and a material of said reflecting layers is one member chosen from a group including aluminum and silver; diameters of said polymer diffusing particulates being between 0.1 μ and 20 μ; proportion of said polymer diffusing particulates to said writing layers being between 2% and 30%.

15. A projection screen, comprising
a first basic material,
a reflecting layer over an upper side of the first basic material,
at least one diffusing layers over an upper side of the reflecting layer,
a second basic material over an upper side of an uppermost one of the diffusing layers,
a writing layer coating an upper side of the second basic material, and
a blackening layer over a lower side of the first basic material.

16. The projection screen as recited in claim 15, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone, and a material of said reflecting layers is one member chosen from a group including aluminum and silver; diameters of said polymer diffusing particulates being between 0.1 μ and 20 μ; proportion of said polymer diffusing particulates to said writing layers being between 2% and 30%.

17. A projection screen, comprising
a first basic material,
a first diffusing layer over an upper side of said first basic material,
a second basic material over an upper side of said first diffusing layer,
a second diffusing layer over an upper side of said second basic material,
a writing layer coating an upper side of said second diffusing layer,
a reflecting layer over a lower side of said first basic material, and
a blackening layer over a lower side of said reflecting layer.

18. The projection screen as recited in claim 17, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone, and a material of said reflecting layers is one member chosen from a group including aluminum and silver; diameters of said polymer diffusing particulates being between 0.1 μ and 20 μ; proportion of said polymer diffusing particulates to said writing layers being between 2% and 30%.

19. A projection screen, comprising
a first basic material,
a reflecting layer over an upper side of said first basic material,
a first diffusing layer over an upper side of said reflecting layer,
a second basic material over an upper side of said first diffusing layer,
a second diffusing layer over an upper side of said second basic material,
a writing layer coating an upper side of said second diffusing layer, and
a blackening layer over a lower side of said first basic material.

20. The projection screen as recited in claim 19, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone, and a material of said reflecting layers is one member chosen from a group including aluminum and silver; diameters of said polymer diffusing particulates being between 0.1 μ and 20 μ; proportion of said polymer diffusing particulates to said writing layers being between 2% and 30%.

21. A projection screen, comprising
a first basic material,
a reflecting layer over an upper side of said first basic material,
at least one diffusing layers over an upper side of said reflecting layer,
a second basic material over an upper side of an uppermost one of said diffusing layers,
a writing layer coating an upper side of said second basic material,.
a black adhesive layer over a lower side of said first basic material, and
a detaching film over a lower side of said black adhesive layer.

22. The projection screen as recited in claim 21, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone, and a material of said reflecting layers is one member chosen from a group including aluminum and silver; diameters of said polymer diffusing particulates being between 0.1 μ and 20 μ; proportion of said polymer diffusing particulates to said writing layers being between 2% and 30%.

23. A projection screen, comprising
a first basic material,
a first diffusing layer over an upper side of said first basic material,
a second basic material over an upper side of said diffusing layer,
a second diffusing layer over an upper side of said second basic material,
a writing layer coating an upper side of said second diffusing layer,
a reflecting layer over a lower side of said first basic material,
a black adhesive layer over a lower side of said reflecting layer, and
a detaching film over a lower side of said black adhesive layer.

24. The projection screen as recited in claim 23, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone, and a material of said reflecting layers is one member chosen from a group including aluminum and silver; diameters of said polymer diffusing particulates being between 0.1 μ and 20 μ; proportion of said polymer diffusing particulates to said writing layers being between 2% and 30%.

25. A projection screen, comprising
a first basic material,
a reflecting layer over an upper side of said first basic material,
a first diffusing layer over an upper side of said reflecting layer,
a second basic material over an upper side of said first diffusing layer,
a second diffusing layer over an upper side of said second basic material,
a writing layer coating an upper side of said second diffusing layer,
a black adhesive layer over a lower side of said first basic material, and
a detaching film over a lower side of said black adhesive layer.

26. The projection screen as recited in claim 25, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone, and a material of said reflecting layers is one member chosen from a group including aluminum and silver; diameters of said polymer diffusing particulates being between 0.1 μ and 20 μ; proportion of said polymer diffusing particulates to said writing layers being between 2% and 30%.

27. A projection screen, comprising
a basic material,
at least one diffusing layers over an upper side of said basic material,
a writing layer coating an upper side of an uppermost one of said diffusing layers,
a transparent adhesive layer over a lower side of said basic material, and
a detaching film over a lower side of said transparent adhesive layer.

28. The projection screen as recited in claim 27, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone; diameters of said polymer diffusing particulates being between 0.1 μ and 20 μ; proportion of said polymer diffusing particulates to said writing layers being between 2% and 30%.

29. A projection screen, comprising
a basic material,
a writing layer over an upper side of said basic material,
at least one diffusing layers over a lower side of said basic material,
a transparent adhesive layer coating a lower side of a lowermost one of said diffusing layers, and
a detaching film over a lower side of said transparent adhesive layer.

30. The projection screen as recited in claim 29, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone; diameters of said polymer diffusing particulates being between 0.1 μ and 20 μ; proportion of said polymer diffusing particulates to said writing layers being between 2% and 30%.

31. A projection screen, comprising
a basic material,
a writing layer over an upper side of said basic material,
at least one diffusing layer over a lower side of said basic material, said diffusing layers being adhesive; and
a detaching film over a lower side of said diffusing layer.

32. The projection screen as recited in claim 31, wherein said basic materials are made of one member chosen from a group including PET (Polyethylene Terephthalate), PP (Polypropylene), PEN, PE (polyethylene), PA (nylon), PMMA (acryl), and PC (Polycarbonate), and said writing layers have polymer diffusing particulates added therein, which are made of one member chosen from a group including PMMA (acryl), PU, and silicone; diameters of said polymer diffusing particulates being between 0.1 μ and 20 μ; proportion of said polymer diffusing particulates to said writing layers being between 2% and 30%.
